(19) United States
(12) Patent Application Publication
(10) Pub. No.: US 2005/0207156 A1
(43) Pub. Date: Sep. 22, 2005

(54) Flexible light array and fabrication procedure thereof

(75) Inventors: Bily Wang, Hsin Chu City (TW); Jonnie Chuang, Pan Chiao City (TW)

Correspondence Address: TROXELL LAW OFFICE PLLC, SUITE 1404, 5205 LEESBURG PIKE, FALLS CHURCH, VA, 22041, US

(73) Assignee: HARVATEK CORPORATION

(21) Appl. No.: 10/805,346

(22) Filed: Mar. 22, 2004

(51) Int. Cl. F21V 1/00

(52) U.S. Cl. 362/240; 362/225; 362/252; 362/800

(57) ABSTRACT

A flexible light array is constructed to have a flexible substrate with conducting circuits therein, a LED array formed of longitudinally and transversely aligned light emitting diodes respectively electrically connected to the conducting circuits and controllable by a driving circuit to produce a video display, and a flexible plastic member packed on the flexible substrate and the LED array.

### BACKGROUND OF THE INVENTION

1. Field of the Invention

The present invention relates to light emitting devices and more particularly, to a flexible LED display panel. The invention relates also to the fabrication of such a flexible LED display panel.

2. Description of the Related Art

Following fast development of information technology, a variety of LED display panels have been developed and used in different electronic products. These LED display panels may also be used as signboards, signal lights for transportation vehicle, outdoor TV walls. By means of controlling on/off operation of individual light emitting diodes, a LED display panel can show a message or motion picture, which is practical for sending messages to people in real time. However, conventional LED display panels are fragile and not convenient to carry. Further, because conventional LED display panels are not bendable, they have a view angle limitation.

### SUMMARY OF THE INVENTION

The present invention has been accomplished under the circumstances in view. It is therefore the main object of the present invention to provide a flexible light array, which can be used as a flexible LED display panel. It is another object of the present invention to provide a flexible light array, which is convenient to carry and provides a wide view angle. To achieve these and other objects of the present invention, the flexible light array comprises flexible substrate, the flexible substrate having a plurality of conducting circuits therein, and a plurality of light emitting diodes arranged into at least one longitudinally and transversely aligned LED array on at least one of two opposite sides of the flexible substrate and respectively electrically connected to the conducting circuits of the flexible substrate and controllable by a driving circuit to emit light.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a perspective view of a flexible light array constructed according to the present invention;

FIG. 2 is a side view of the flexible light array according to the present invention;

FIG. 3 is a side view of an alternate form of the flexible light array according to the present invention, showing two LED arrays symmetrically arranged on the top and bottom sides of the flexible substrate;

FIG. 4 is a side view of another alternate form of the flexible light array according to the present invention, showing two LED arrays arranged on the top and bottom sides of the flexible substrate in a staggered manner;

FIG. 5A is a side view in section of still another alternate form of the present invention, showing the flexible light array of FIG. 2 packed in a flexible tube;

FIG. 5B is a cross-sectional view of FIG. 5A;

FIG. 6A is a side view in section of still another alternate form of the present invention, showing the flexible light array of FIG. 3 packed in a flexible tube;

FIG. 6B is a cross-sectional view of FIG. 6A;

FIG. 7A is a side view in section of still another alternate form of the present invention, showing the flexible light array of FIG. 4 packed in a flexible tube;

FIG. 7N is a cross-sectional view of FIG. 7A.

FIG. 8A is a side view in section of still another alternate form of the present invention, showing the flexible light array of FIG. 2 molded with a flexible plastic packing layer;

FIG. 8B is a cross-sectional view of FIG. 8A;

FIG. 9A is a side view in section of still another alternate form of the present invention, showing the flexible light array of FIG. 3 molded with a flexible plastic packing layer;

FIG. 9B is a cross-sectional view of FIG. 9A;

FIG. 10A is a side view in section of still another alternate form of the present invention, showing the flexible light array of FIG. 4 molded with a flexible plastic packing layer;

FIG. 10B is a cross-sectional view of FIG. 10A;

FIG. 11 is a circuit block diagram of a 4×4 flexible light array constructed according to the present invention; and

FIG. 12 is a flexible light array fabrication flow chart according to the present invention.

### DETAILED DESCRIPTION OF THE PREFERRED EMBODIMENT

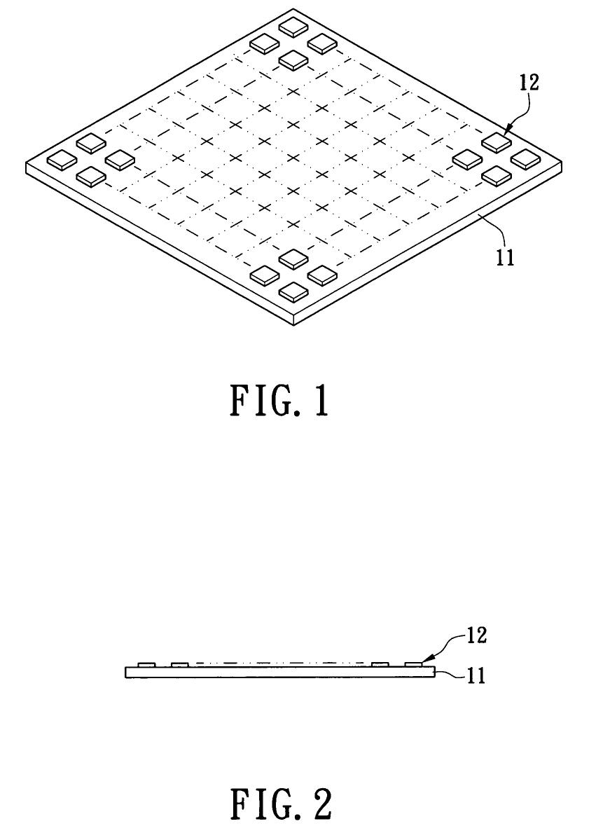

Referring to FIG. 1, a flexible light array is shown comprising a flexible substrate 11 molded from flexible plastic and having conducting circuits (not shown) therein, and a plurality of light emitting diodes arranged into an array of LEDs 12 on one side of the flexible substrate 11 and electrically connected to the conducting circuits in the flexible substrate 11 through a dielectric layer (not shown). This design of flexible light array is practical for use as a signal light means for transportation vehicles, a signboard or an outdoor TV wall for advertising.

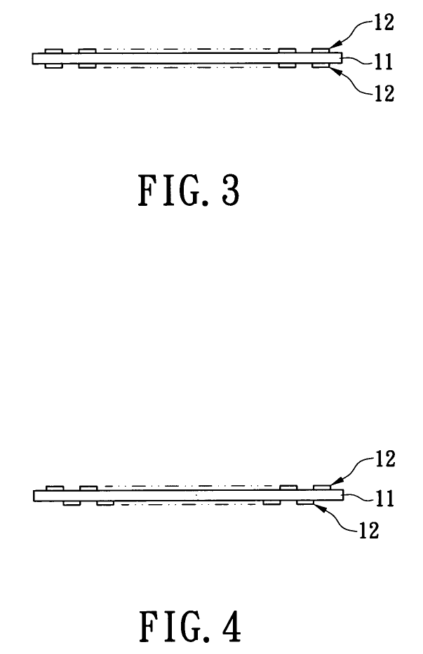

Light emitting diodes may be arranged into an array of LEDs 12 on one side of the substrate 11 as shown in FIG. 2, or into two symmetrical arrays of LEDs 12 on the top and bottom sides of the substrate 11 as shown in FIG. 3.

FIG. 4 shows the light emitting diodes alternatively arranged on the top and bottom sides of the substrate 11, forming two staggered arrays of LEDs 12 at the two sides of the substrate.

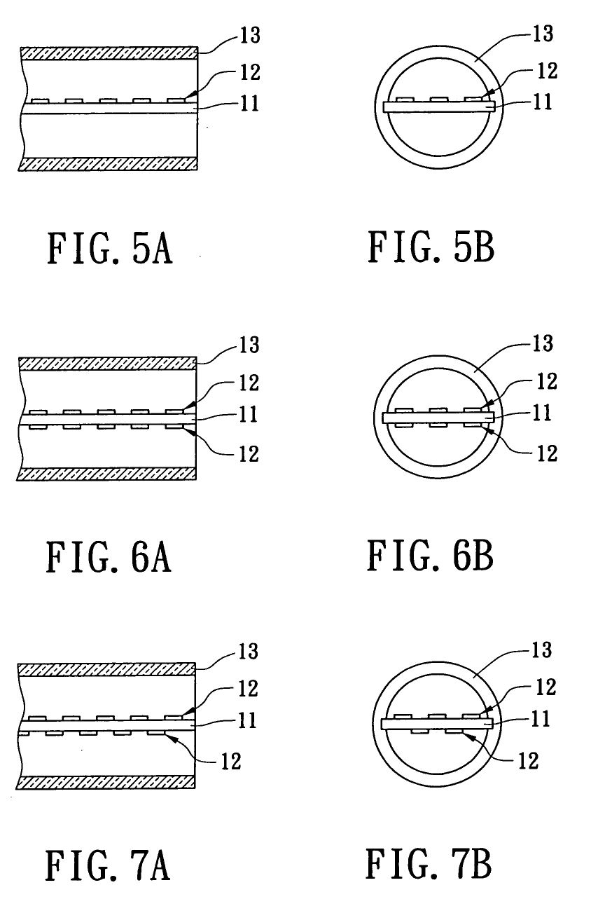

Referring to FIGS. 5A and 5B, the flexible lighting array of FIG. 2 may be packed in a flexible tube 13 that admits light. The flexible tube 13 may be coated with a layer of color filter coating.

Referring to FIGS. 6A and 6B, the flexible light array of FIG. 3 may be packed in a flexible tube 13 that admits light. The flexible tube 13 may be coated with a layer of color filter coating.

Referring to FIGS. 7A and 7B, the flexible light array of FIG. 4 may be packed in a flexible tube 13 that admits light. The flexible tube 13 may be coated with a layer of color filter coating.

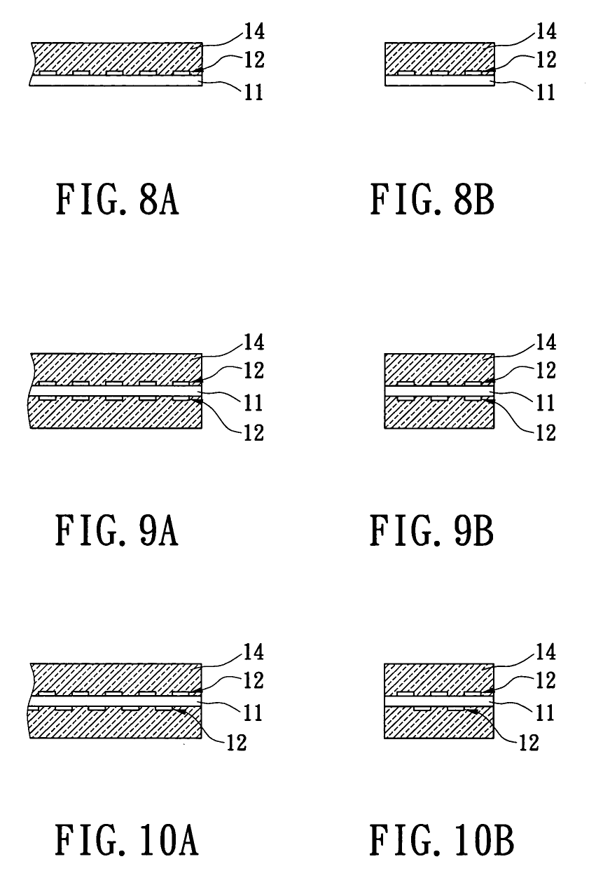

Referring to FIGS. 8A and 8B, a flexible plastic packing layer 14 may be molded on the substrate 11 of the flexible light array shown in FIG. 2, keeping the array of LEDs 12 embedded in the flexible plastic packing layer 14. The plastic packing layer 14 admits light and is coated with a layer of color filter coating.

Referring to FIGS. 9A and 9B, a flexible plastic packing layer 14 may be molded on the top and bottom sides of the substrate 11 of the flexible light array shown in FIG. 3, keeping the two arrays of LEDs 12 embedded in the flexible plastic packing layer 14. The flexible plastic packing layer 14 admits light and is coated with a layer of color filter coating.

Referring to FIGS. 10A and 10B, a flexible plastic packing layer 14 may be molded on the top and bottom sides of the substrate 11 of the flexible light array shown in FIG. 4, keeping the two arrays of LEDs 12 embedded in the flexible plastic packing layer 14. The flexible plastic packing layer 14 admits light and is coated with a layer of color filter coating.

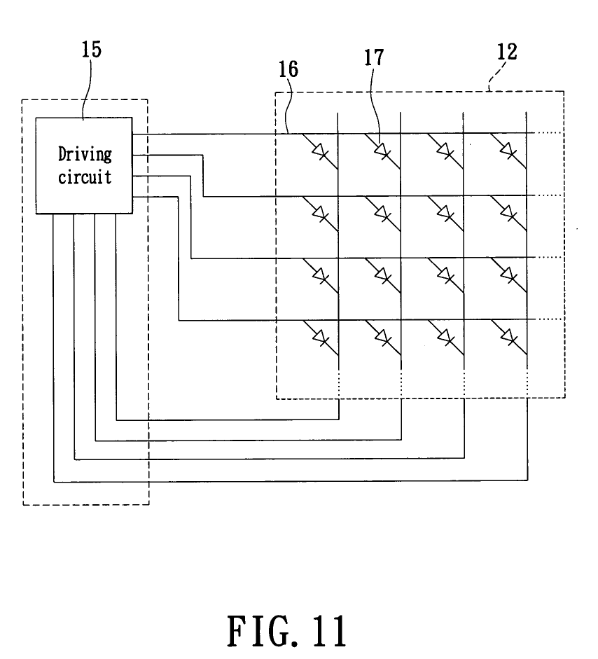

FIG. 11 shows a 4×4 flexible light array constructed according to the present invention. As illustrated, the flexible light array comprises a driving circuit 15, conducting circuits 16, and light emitting diodes 17. The light emitting diodes 17 are arranged into a 4×4 array of LEDs 12 respectively installed in the conducting circuit 16. The driving circuit 15 is electrically connected to the conducting circuits 16, and adapted to control on/off of the light emitting diodes 17. Therefore, the array of LEDs 12 can be controlled to produce a visual signal or motion display for use as a flexible LED display panel for adverting or transportation vehicle.

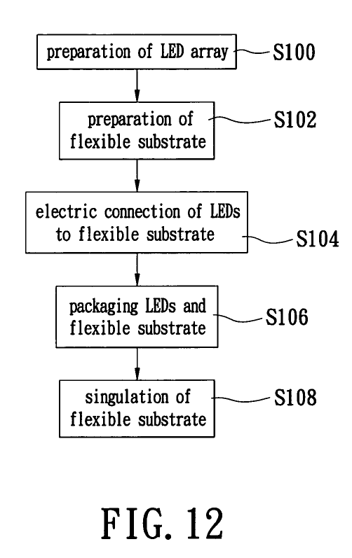

Referring to FIG. 12, a flexible light array fabrication procedure comprises the steps of: preparation of LED array S100 where a number of light emitting diodes are arranged into a LED array, preparation of flexible substrate S102 where a flexible substrate is prepared having conducting circuits therein, electric connection of LEDs to flexible substrate S104 where the prepared LED array is electrically connected to the conducting circuits of the flexible substrate, packaging S106 where the flexible substrate is packed with a flexible plastic packing layer or a flexible tube, and singulation S108 where the package thus obtained is cut subject to the desired size. After singulation S108, a driving circuit 15 is prepared and connected to the conducting circuits 16 of the substrate (see also FIG. 11 for controlling on/off operation of the light emitting diodes 17.

As indicated above, the invention provides a flexible light array, which comprises a flexible substrate, at least one LED array installed in the flexible substrate, and a driving circuit adapted to control on/off operation of the light emitting diodes of the at least one LED array.

A prototype of flexible light array and its fabrication procedure has been constructed with the features of the annexed drawings of FIGS. 1-12. The flexible light array and its fabrication procedure functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

1. A flexible light array comprising:
a flexible substrate, said flexible substrate having a plurality of conducting circuits therein; and
a plurality of light emitting diodes arranged into at least one longitudinally and transversely aligned LED array on at least one of two opposite sides of said flexible substrate and respectively electrically connected to the conducting circuits of said flexible substrate and controllable by a driving circuit to emit light.

2. The flexible light array as claimed in claim 1, wherein said light emitting diodes are arranged into one longitudinally and transversely aligned LED array on one side of said flexible substrate, forming with said flexible substrate a flexible LED display panel.

3. The flexible light array as claimed in claim 2, wherein said flexible LED display panel is used as a signal light for a transportation vehicle.

4. The flexible light array as claimed in claim 2, wherein said flexible LED display panel is used as a lighting signboard.

5. The flexible light array as claimed in claim 2, wherein said flexible LED display panel is used as an outdoor TV wall.

6. The flexible light array as claimed in claim 1, wherein said light emitting diodes are arranged into two longitudinally and transversely aligned LED arrays symmetrically disposed on the two opposite sides of said flexible substrate, forming with said flexible substrate a double-sided LED display panel.

7. The flexible light array as claimed in claim 1, wherein said light emitting diodes are arranged into two longitudinally and transversely aligned LED arrays disposed on the two opposite sides of said flexible substrate in a staggered manner, forming with said flexible substrate a double-sided LED display panel.

8. The flexible light array as claimed in claim 1, further comprising a flexible light-transmitting packing tube having said light emitting diodes and said flexible substrate packed therein.

9. The flexible light array as claimed in claim 8, wherein said flexible light-transmitting packing tube is coated with a layer of color filter coating.

10. The flexible light array as claimed in claim 1, further comprising a flexible light-transmitting plastic packing layer molded on said flexible substrate over said light emitting diodes.

11. The flexible light array as claimed in claim 10, wherein said flexible light-transmitting plastic packing layer is coated with a layer of color filter coating.

12. A flexible light array fabrication procedure, comprising the steps of:
(a) preparing at least one LED array, each having a plurality of longitudinally and transversely aligned light emitting diodes;
(b) preparing a flexible substrate having a plurality of conducting circuits therein;
(c) electrically connecting the light emitting diodes of said at least one LED array to the conducting circuits of said flexible substrate;
(d) packing said flexible substrate and said at least one LED array with flexible light-transmitting packing means; and
(e) cutting said flexible substrate subject to the desired size.

13. The flexible light array fabrication procedure as claimed in claim 12, wherein said step (d) packs said flexible substrate and said at least one LED array with a flexible light-transmitting plastic packing layer by molding.

14. The flexible light array fabrication procedure as claimed in claim 12, wherein said step (d) packs said flexible substrate and said at least one LED array with a flexible light-transmitting tube.

15. The flexible light array fabrication procedure as claimed in claim 12, wherein said step (e) singulates the device thus obtained into individual flexible light arrays by cutting subject to the desired size.

16. The flexible light array fabrication procedure as claimed in claim 12, further comprising step (f) after said step (e), said step (f) preparing a driving circuit and then electrically connecting said driving circuit to the conducting circuits of said flexible substrate for enabling said driving circuit to turn said light emitting diodes on or off.
